(19) United States
(12) Patent Application Publication
(10) Pub. No.: US 2015/0181819 A1
(43) Pub. Date: Jul. 2, 2015

(54) Method and System for Automated Plant Watering

(71) Applicants: Samel Celebi, Summit, NJ (US); Kaya Celebi, New York, NY (US)

(72) Inventors: Samel Celebi, Summit, NJ (US); Kaya Celebi, New York, NY (US)

(21) Appl. No.: 14/144,555

(22) Filed: Dec. 31, 2013

(51) Int. Cl. A01G 27/00; B64C 39/02

(52) U.S. Cl. CPC A01G 27/006; B64C 39/024; B64C 2201/146; B64C 2201/12; B64C 2201/108; B64C 2201/024; B64C 2201/022

(57) ABSTRACT

A system for automatic watering of a plurality of plants using a programmable airborne vehicle (AV). The AV is capable of locating the plants to be watered via various wireless, sonar and pattern-recognition-based means. The AV is programmed with scheduling information such as the amount of water and the frequency of watering for each plant. The optional base unit acts as a refilling and recharging station for the AV.

### BACKGROUND OF THE INVENTION

I. Field

The following description relates generally to the field of horticulture and more specifically to plant watering systems (PWS).

II. Background

Whether they are grown for decorative, production or health reasons plants are an integral part of human life. Trees, house and garden plants add unmistakable beauty with their foliage and flowers to homes, offices and gardens. They are not only aesthetically pleasing to the eye, but according to a NASA study [1] they also clean the air. The study has identified several houseplants that filter out common volatile organic compounds (VOCs) such as formaldehyde (present in rugs, vinyl, grocery bags), benzene (commonly used in book printing) and trichloroethylene (solvents, inks, paints).

As part of the photosynthetic and respiratory processes, plants release moisture vapor, which increases the humidity of the air around them. Plants release roughly 97% of the water that they take in. Studies at the Agricultural University of Norway [2] document that using plants in interior spaces decreases the incidence of dry skin, colds, sore throats and dry coughs.

Adding plants to hospital rooms speeds recovery rates of surgical patients, according to researchers at Kansas State University, Compared to patients in rooms without plants, patients in rooms with plants request less medication, have lower heart rates and blood pressures, experience less fatigue and anxiety and are released from the hospital earlier [3].

Trees and plants require maintenance, At a minimum, they need to be watered periodically. Different trees and plants may require different amounts of water at different time intervals. Keeping up with the diverse watering needs of a collection of trees and plants may become a time consuming chore that requires good planning. This is challenging especially for individuals with busy schedules or those away from home due to vacation or frequent traveling. Also, in an indoor setting some plants may be located in hard to reach areas (e.g. plants hanging from high ceilings) which poses additional challenges for their upkeep.

Some noteworthy prior art that addresses the issue of plant watering from various different angles are as follows:

U.S.2002/0053604 A1 titled “Automatic Semi-Conductor Condensate Flower-Watering Device” the invention measures and adjusts the soil moisture using a semiconductor based apparatus. The proposed apparatus is immobile, meaning one apparatus is needed per flower or plant and the invention does not address the problem of water delivery. It assumes that the water is collected thru condensation or rain.

U.S. Pat. No. 8,413,372 B2 titled “Plant Watering Systems” by Douglas King, the inventor proposes a series of spikes buried into the soil. The water is delivered through a network of pipes to the spikes. This invention may suffer from practical installation issues particularly indoors and large outdoor areas.

U.S.2004/0139650 A1 titled “Automatic Portable Watering System for indoors plant” by Ataul Haq, the inventor proposes a water reservoir based apparatus which gets triggered by a moisture sensitive gel buried under the soil. Due its immobile nature, the apparatus can serve only one plant. The size of the reservoir has a critical role in determining how often it should be refilled. If it's too small it may not be able to sustain the plant for the desired period of time, whereas if it's too large it may suffer from aesthetic issues.

In U.S.2007/0089365 A1 titled “Plant Watering System” by Rick Rowe, the inventor proposes multiple automatic dispensers placed near plants. The dispensers are controlled by remotely by a computer. The dispensers are immobile meaning that it is necessary to place one dispenser next to each plant. Also, due to their omnipresence next to the plants they may pose aesthetic concerns in some situations.

### SUMMARY OF THE INVENTION

A primary object and feature of the present invention is to provide an automated system for watering trees and plants The following presents a simplified summary of one or more aspects in order to provide a basic understanding of such aspects. this summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with a preferred embodiment hereof, the invention provides an automated watering system, relating to dispersing at least one aqueous liquid from at least one aqueous liquid source into the soil part of the plant or tree. The invention uses an airborne vehicle (a.k.a. drone) to transport and deliver liquid from the source to the targeted trees and plants. Alternate embodiments of the invention include at least one or more of the following components: i) an airborne vehicle equipped with a storage tank that is capable of carrying liquids over the air ii) a base unit which acts as the water source and/or the battery charger for the airborne vehicle iii) identification elements such as printed labels and/or radio frequency ID (RFD) tags collocated with the individual plants and trees that facilitate the airborne vehicle unit to locate them iv) identification elements such as printed labels and/or radio frequency (RFID) tags collocated with the base unit that facilitate the airborne vehicle to locate the base unit v) a receptacle element that is collocated with the plant or the tree which facilitates the water intake. vi) a personal digital assistant, smartphone, computer, tablet or a netbook through which a user can enter water scheduling information.

In one potential embodiment of the invention, a battery operated airborne vehicle recharges its batteries while parked on or near the base unit. Also, in this aspect, the airborne vehicle fills up its tank from the water source while parked on or next to the base unit. Furthermore, with its tank filled, the airborne unit takes off from the base unit, locates the plants to be watered, flies towards them, hovers over or lands next to them and delivers the water.

In a further aspect, the airborne vehicle and or the base unit are optionally equipped with processors and computer readable memory medium. Furthermore, processor units may execute computer programs to find the plant locations. In addition, the airborne vehicle may rely on visual cues, global positioning system ((PS) devices, ultrasound, laser or other forms of electromagnetic waves to locate the plants or trees to water. In one aspect, radio frequency transceivers—commonly known as RE ID tags—collocated with plants may assist the airborne vehicle in finding the plant and the tree locations. In another aspect, reflectors, signs, printed labels, signs, patterns and other visual cues that are recognizable by the airborne vehicle are collocated with the plants for location assistance.

In a preferred embodiment of the invention the airborne vehicle and the base unit may communicate with each other via wireless medium. Moreover, the wireless communication leverages standard radio access technologies such as WiFi (802.11), 3GPP Long Term Evolution (LTE) and LTE-Advanced (LTE-A), Bluetooth, WCDMA, CDMA2000, Zigbee, proprietory protocols as well as ultrasound waves or optical communication.

In another aspect, the processor unit onboard the airborne unit or the base unit, or both can exchange water scheduling information (WSI). Related to that that, WSI includes data such as which plants to water, when and by how much as well the location of the plants.

In one sample embodiment of the system, the plant watering scheduling information (WSI) can be stored into the base unit's memory. Alternately, this information can be stored in the airborne vehicle's memory. In one nonlimiting aspect, the user can enter the WSI manually through a keyboard or a series of buttons. In another aspect, the user can enter the scheduling data first through another programmable device such as computer, netbook, personal digital assistant, tablet computer or a smartphone which is later transferred to the base unit and/or the airborne vehicle's memory via wired or wireless communication such as WiFi, Bluetooth, Zigbee protocols.

In another aspect, WSI can be first stored inside the memory of a computer device memory such a personal digital assistant, laptop computer, netbook or a personal computer and then transferred to airborne vehicle memory via wireless means.

In another aspect the base unit processor is capable of performing speech recognition and the user enters the WSI in the form of verbal commands. According to this, the base unit stores the WSI in its memory and communicates it to the airborne vehicle.

In another embodiment of the invention, the airborne vehicle's processor is capable of performing speech recognition and the user enters the WSI in the form of verbal commands. According to this, after decoding the verbal commands, the AV processor stores the WSI in its memory.

Yet in another aspect, upon locating the plant targeted for watering, the airborne vehicle lands next to the said plant or hovers in the air on top of it. The airborne unit delivers the water wherein the liquid may be delivered in the form of a spray. Also, in delivering the liquid, the airborne unit may use a pump to ensure steady water flow or simply rely on gravitational force and allow the water to drip from its tank over to the plant. Alternatively, the airborne unit may use a pipe or a straw to deliver the water. Additionally, if the plant is equipped with a receptacle, the airborne unit, while hovering in the air may aim the water at the receptacle intake for a targeted delivery. Furthermore, the airborne unit may make multiple watering trips for each plant and tree where it fills up its tank, then waters the plant and then goes back to the base unit for a refill and repeats the process.

### BRIEF DESCRIPTION OF THE DRAWINGS

FIG. 1 illustrates an airborne vehicle hovering over an indoor plant and watering it.

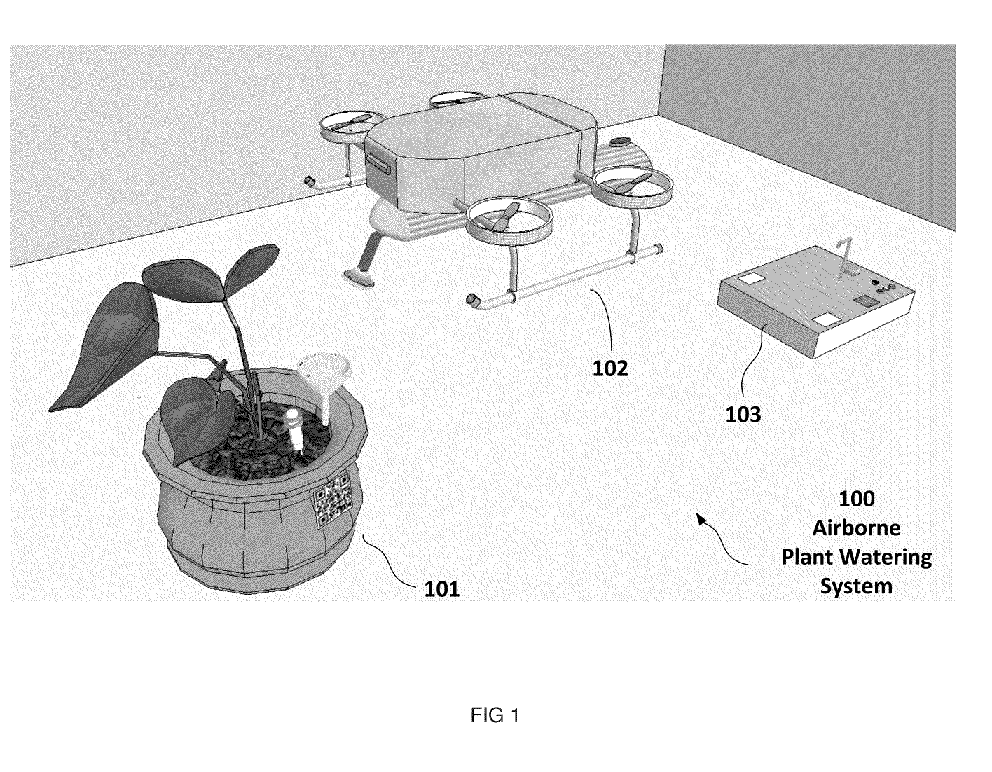

FIG. 2 provides a close up view of the airborne vehicle identifying its individual parts.

FIG. 3 displays the airborne from another angle, magnified for better illustrate the preferred features.

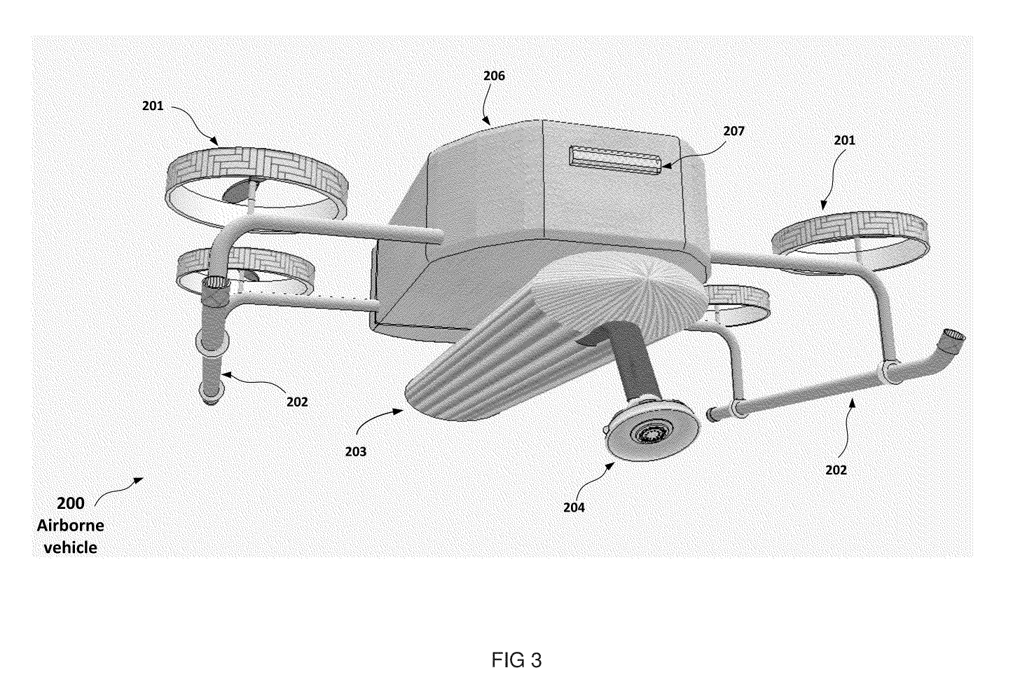

FIG. 4 shows an exploded perspective of the plant to be watered.

FIG. 5 provides a close up view of the base unit.

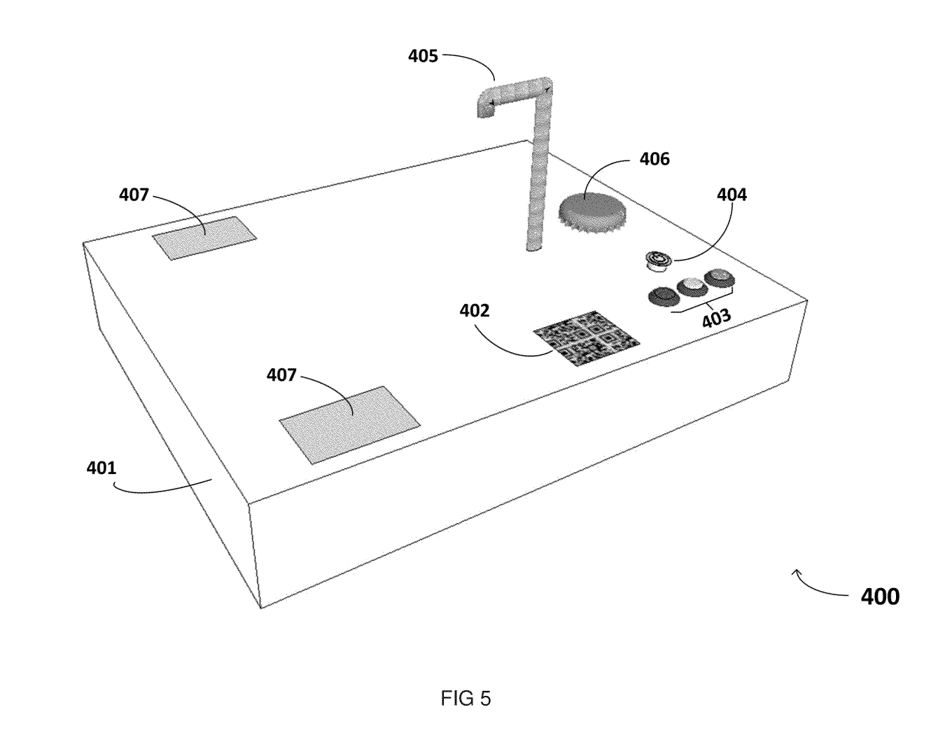

FIG. 6 illustrates the airborne unit parked on top of the base unit while refilling its water tank and recharging its batteries.

FIG. 7 displays wireless transfer of water scheduling information (WSI) from alternate sources.

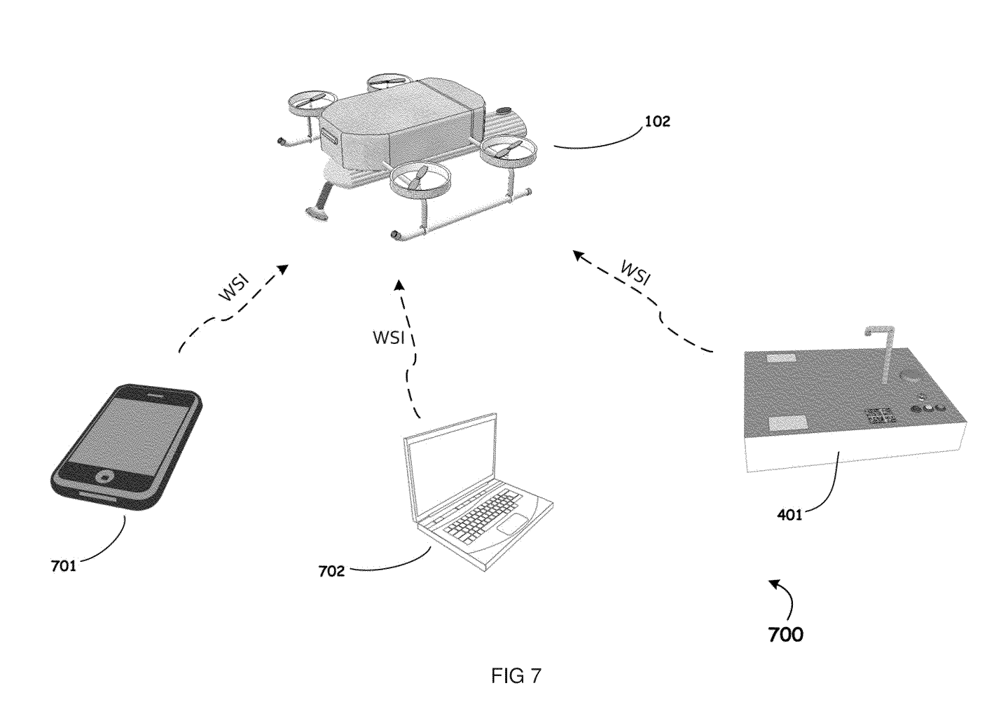

FIG. 8 illustrates water scheduling information table.

FIG. 9 displays the high level flow of watering operation.

### DETAILED DESCRIPTION

0 displays a high level perspective of the airborne plant watering system 100 which is comprised of the airborne vehicle (AV) 102, the plant to be watered 101 and the base unit 103. It is envisioned that after recharging it batteries and refilling its water tank while parked on the base unit 103, the airborne vehicle 102 takes off, flies to and hovers over the plant to be watered 101, sprays water over the plant 101 and returns back to its base unit 103. The airborne vehicle repeats this process periodically based on a schedule set by the user.

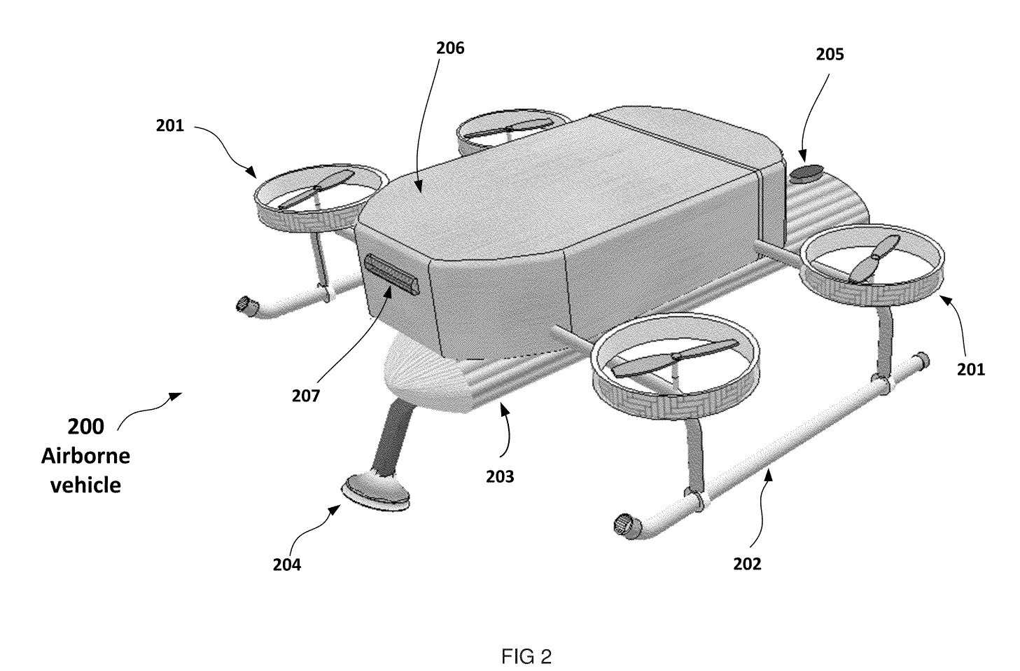

A close up view of the AV 200 is shown in FIG. 2. In one aspect the AV gets its lift power from propellers 201. The vehicle may be battery powered. The legs 202 not only provide standing support for the vehicle but also act as conductive terminals used during recharging. The vehicle carries a tank 203 that is capable of storing water or other aqueous fluids that are deemed nutritious to the plant. The tank is filled up through the opening 205. The tank's water outlet is typically a nozzle 204 reminiscent of a bathroom shower head.

In another aspect of the invention, balloons filled with buoyant gas may be attached to the AV 200 for additional lift power.

According to some present aspects of the disclosure the AV 200 is equipped with an optional onboard processor and computer readable memory medium. The processor may execute computer programs. The programs may help the vehicle find the plant locations. Furthermore, in some aspects, the programs may also help scheduling decisions with regards to which plant to water, when and by how much. The programs may also help coordinate the communication between the vehicle, the base unit 103 and other network devices shown in Error! Reference source not found., such as a smartphone 701 or a laptop computer 702.

According to some present aspects, the base unit 103 is equipped with an onboard processor and a computer readable memory medium. The processor may execute computer programs. The programs may help scheduling decisions with regards to which plant to water, when and how much. If the scheduling decisions are handled by the base unit's processor they are communicated to the airborne vehicle 200. The base unit may also provide directional information to the airborne vehicle that would facilitate the vehicle find the plants to be watered. In one sample embodiment, the direction information may be stored and communicated in the form of plant coordinates. In another embodiment the direction information may be in the form of turn by turn directions.

In yet further related aspects, the airborne vehicle 200 and or the base unit 103 may include radio transceiver components. Transceivers may also include a network interface for connecting to one or more other communication devices or the like. Transceivers may optionally include a component for storing information, such as, for example, a memory device/component. The computer readable medium or the memory component may be operatively coupled to onboard processors via a bus.

In one aspect, the airborne vehicle 200 and the base unit 103 may communicate with each other via wireless medium. The protocols used for wireless communication may be based on the variants of the standard radio access technologies such as WiFi (802.11), Long Term Evolution (LTE, 3GPP), CDMA, UTRA, CDMA2000, IS-95, IS-2000, TDMA, IS-856, Global System for Mobile Communications (GSM), Ultra Mobile Broadband (UMB), IEEE 802.16 (WiMAX), IEEE 802.20, Flash-OFDM, Bluetooth, Zigbee, Near Field Communications (NFC), ultrasound or optical or proprietary communication protocols.

In a preferred embodiment of the disclosure the airborne vehicle 200 may be equipped with a location finding device. The location finding device can take the form of a compass or a global positioning systems (GPS) device. Alternately, the location finding device can determine the location of AV by triangularizing the received reference signals from known local sources. For example, in an indoor environment these sources could be a collection of beacon transmitters attached to different corners of a room. The location finding device may use arrival times of the beacons to estimate the AV location with regards to the beacon sources.

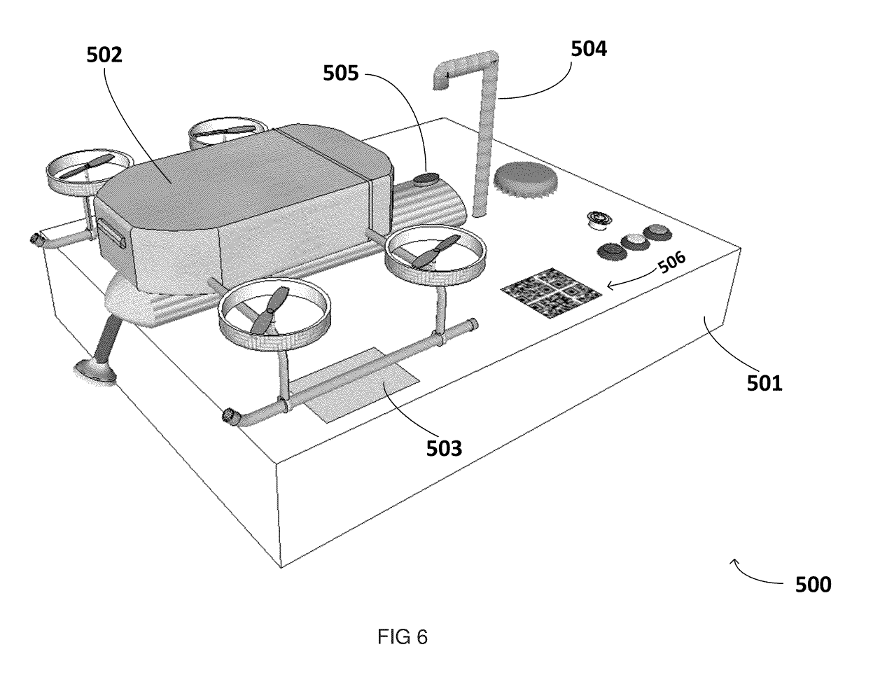

FIG. 6 shows the airborne vehicle 502 when it is parked on the base unit 501. The base unit may play multiple roles in the watering system. In one aspect it may be a refilling station for the airborne vehicle. It fills up the vehicle's tank 203 by pouring or pumping liquid or water into the vehicle tank opening 505 through a pipe 504. The base unit 501 may have its own water tank inside the enclosure 401. Base unit tank gets filled through the opening 406.

In another aspect, the base unit 501 may serve as an electrical charging station for the airborne vehicle 502. In this context, the AV positions itself on the base unit such that its rods 202 establish electrical contact with the base unit's charging plates 407 shown in FIG. 6.

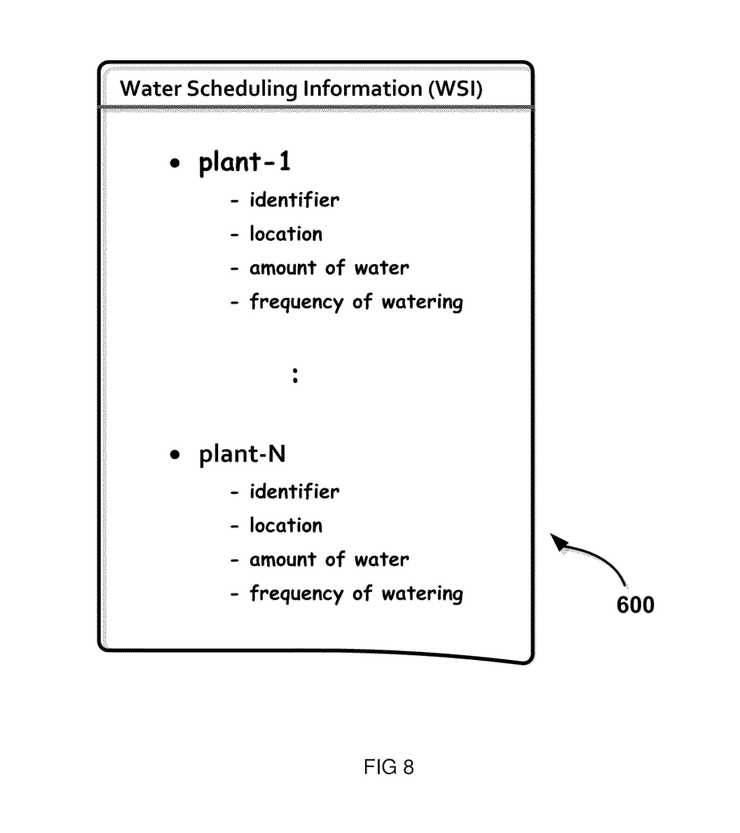

In another aspect, the base unit 501 acts as a programming interface for the user. The user may program the watering system by using the keys 403. The programming information can include water scheduling information (WSI) 600 such as which plant to water, how often and by how much (FIG. 8) as well as the plant location information. Plant location can be with regards to the base unit or a predetermined reference point. WSI may be stored in the base unit's memory and transferred to the airborne vehicle's memory at a later time.

Besides using the keys 403, in some other aspect, the programming information can be entered verbally by the user. According to this scheme, the base unit or the AVcaptures and decodes the user's verbal commands through a speech recognition software and stores them in memory. A sample verbal command may be ‘water plant number 4 once every 3 days by 5 ounces’.

In another aspect the WSI can be first entered through a smartphone 701, personal computer 702, tablet computer or a separate terminal by the user and then transferred to the memory of the base unit or the memory of the airborne vehicle. Each of these devices may have an application software that facilitate the entry and transfer of scheduling information.

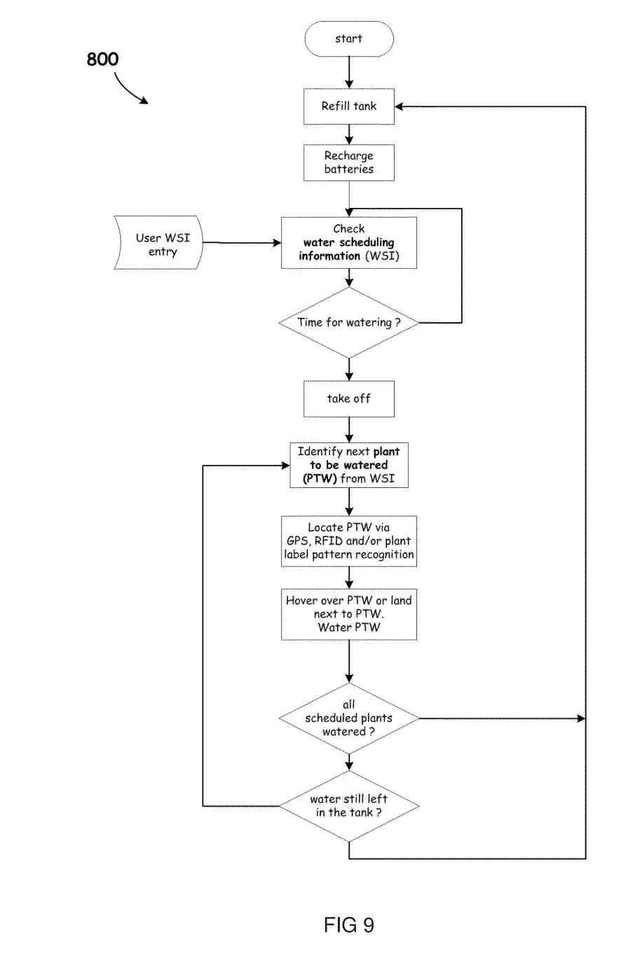

FIG. 9 depicts a sample flow 800 for the plant watering operation. In a preferred embodiment of the proposed system the airborne vehicle 502 depicted in FIG. 6 periodically takes off from the base unit 501 after refilling its tank and recharging its batteries. The timing of the takeoff is determined by the scheduling information entered by the user. The scheduling information is either stored in the airborne vehicle's memory or first stored in the base unit memory and then communicated to the airborne vehicle.

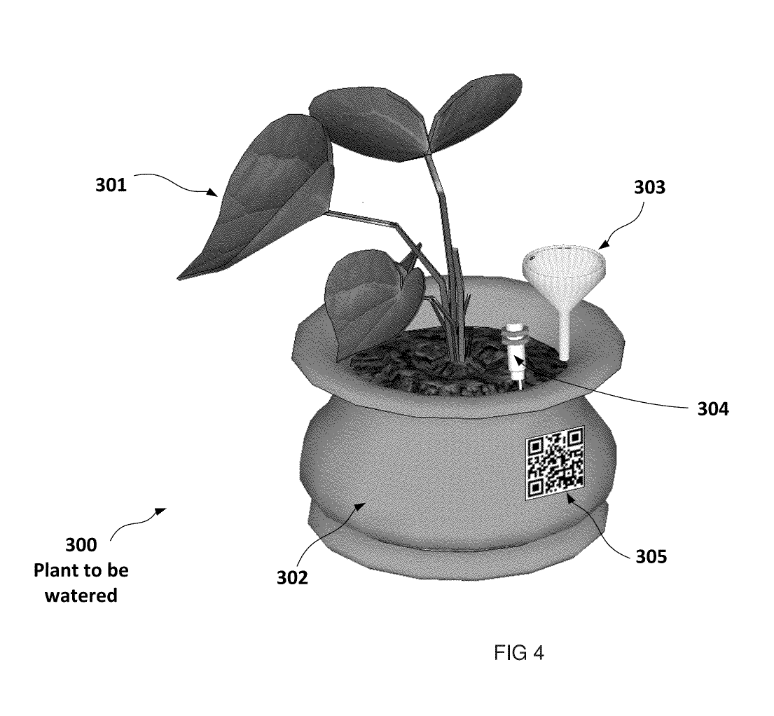

In a sample embodiment of the disclosure, once airborne, the vehicle tries to locate the plants that are scheduled to be watered. FIG. 4 depicts an exemplary plant 301 that is targeted for watering. In some aspects the plant sits in a container 302. The container may have a visual identifier 305 to help the airborne vehicle recognize it. In some aspects the vehicle may use sensor 207 and image recognition software to match the visual identifier to the patterns stored in its memory. Alternatively, the airborne vehicle may rely on the global positioning system or indoor location systems to guide itself near the next plant to be watered. In another aspect, the transmitters 304, such as RFID tags placed on or near the plant can help locate the plant. RFID tags may be passive or active. Passive versions would respond to a query from the airborne vehicle with the ID of the plant. Active versions would periodically send out location and ID information for the plant without waiting for a query.

In some aspect the airborne vehicle may be equipped with proximity sensors 207. The sensors provide warning signals if the vehicle gets too close to an object. When it receives the warning signal, the vehicle readjusts it flight path to avoid collision with the object.

Once the airborne vehicle locates the plant 301 it flies towards the plant and hovers near it as illustrated in 0. The airborne vehicle 102 releases water through its nozzle 204. The vehicle may use a pump to spray water or alternately lets the water drip over the plant with the help of the gravitational force. In some aspects the plant 301 may be equipped with a receptacle 303 as shown in FIG. 4. The receptacle has the shape of a funnel and it helps with the water intake by minimizing water spillage. If a receptacle is available the airborne vehicle aims its nozzle towards it for more reliable delivery.

In one sample aspect the airborne vehicle is equipped with solar panels which allows its batteries to be recharged using light energy.

### References

[1] NASA clean air study. http://en.wikipedia.org/wiki/List of air-filtering plants

[2] http://www.organicslant.com/0000085-house-plants-purify-air-nasa-study.html

[3] Seong-Hyun Park. Ph.D. Dissertation, “Randomized clinical trials evaluating therapeutic influences of ornamental indoor plants in hospital rooms on health outcomes of patients recovering from surgery,” http://krex.k-state.edu/dspace/handle/2097/227

1. An automated airborne plant watering system, relating to dispersing at least one aqueous liquid over a plant at scheduled intervals, comprising:
a. a programmable airborne vehicle (AV) for delivering liquid to a plant, tree or flower, comprising:
i. at least one tank capable of storing liquids comprising:
an opening for liquid delivery in the form of a nozzle, pipe or shower head, and
a capped opening for allowing liquid filling into said tank.
ii. at least one propeller capable of providing lift and drag power to said AV
iii. at least one motor unit delivering power to said propellers
iv. a processor
v. a memory coupled to said processor for storing data
vi. at least one rechargeable battery unit delivering electrical power to said motor and said processor and said memory unit
b. at least one plant to be watered (PTW) comprising:
i. at least one plant standing outside in soil, or
ii. at least one plant standing in a pot or a container

2. The invention of claim 1 wherein said AV further comprising
a. at least one leg made from conductive material
b. wherein said legs providing standing support for said AV
c. wherein said legs are used as point of contacts during recharging of said batteries

3. The invention of claim 1 wherein said AV further comprising a wireless transceiver apparatus capable of sending and receiving information to and from other transceivers alike.

4. The invention of claim 1 further comprising:
a. a balloon attached to AV body
b. wherein said balloon filled with a buoyant gas.

5. The invention of claim 1 wherein said AV further comprising:
a. a watering scheduling information (WSI) comprising:
i. a list of plants to be watered (PTW)
ii. a list of location of said plants
iii. a list of amount of water to be given to each said plant a list of frequency of watering to be applied to each said plant, or alternatively a list of watering times or dates for each said plant
b. wherein said WSI is stored in said AV memory

6. The invention of claim 5 further comprising:
a. a user entering said WSI into a computer or a smartphone or a personal digital assistant memory via keyboard, or,
b. a user entering said WSI into a computer or a smartphone or a personal digital assistant memory using voice commands.
c. wherein said computer, smartphone or personal digital assistant transferring said WSI information from said memory to said AV via wireless communication
d. wherein said AV storing received WSI information into said AV memory.

7. The invention of claim 1 wherein said AV further comprising:
a. at least one proximity sensor (PS) apparatus attached to the body of said AV,
b. wherein said PS is capable of generating electrical alert signals when objects are nearby,
c. wherein said PS is electrically connected to said processor,
d. wherein said processor changing said AV flight direction based on received PS signals to avoid collision with nearby objects.

8. The invention of claim 1 further comprising:
a. a base unit (BU) serving as a liquid refilling station for said AV.
b. wherein said BU serving as a recharging station for said battery.

9. The invention of claim 8 wherein said BU further comprising:
a. a processor
b. a memory coupled to said processor for storing data
c. a wireless transceiver apparatus capable of sending and receiving information to other transceivers alike.

10. The invention of claim 8 further comprising:
a. a base unit label (BUL) with a distinctive pattern imprinted
a. wherein said BUL is attached to said BU surface.
b. wherein said BUL pattern is stored in said AV's said memory
c. wherein said AV processor is able to identify said BUL by applying pattern recognition algorithms to images captured by said image sensor (IS).

11. The invention of claim 1 further comprising:
a. at least one plant label (PL) with a distinctive pattern for purposes of plant identification
b. wherein each said PL is attached to each said plant's body, or each said pot or each said container
c. wherein each said PL pattern is stored in said AV's said memory
d. wherein said AV processor is able to identify said PL by applying pattern recognition algorithms to images captured by said image sensor (IS).

12. The invention of claim 1 wherein said AV further comprising:
a. plurality of images of plant labels (PL) are stored in said AV memory
b. an image of base unit label (BUL) is stored in said AV memory
c. at least one image sensor (IS) attached to said AVI is capable of capturing images,
d. wherein said captured images transferred to said processor,
e. wherein pattern recognition is applied to said images by said processor,
f. wherein said processor determines if said captured images match patterns stored in said memory

13. The invention of claim 8 further comprising:
a. a radio frequency ID (RFID) tag
b. wherein said RFID tag is attached to said BU body
c. wherein said RFID tag transmitting signals
d. wherein said AV is capable of finding said RFID location by processing said RFID signals

14. The invention of claim 8 wherein said BU further comprising:
a. a watering scheduling information (WSI) comprising:
i. a list of plants to be watered (PTW)
ii. a list of location of said plants
iii. a list of amount of water to be given to each said plant
iv. a list of frequency of watering to be applied to each said plant, or
v. a list of watering times or dates each said plant
b. wherein said WSI is stored in said BU memory

15. The invention of claim 14 wherein said BU further comprising a keyboard for user to enter said WSI.

16. The invention of claim 14 wherein said BU further comprising:
a. a microphone converting user's verbal said WSI entries into electrical signals
b. wherein said processor is capable of decoding said microphone's signals through speech recognition and storing said WSI in said memory

17. The invention of claim 14 comprising:
a. said BU processor reading said WSI from said BU memory and transmitting its content to said AV using said wireless transceiver.
b. said AVI processor copying received WSI information into said AV memory

18. The invention of claim 5 wherein said AV further comprising:
a. a microphone converting user's verbal said WSI entries into electrical signals
b. wherein said processor is capable of decoding said microphone's signals through speech recognition and storing said WSI in said memory

19. The invention of claim 1 further comprising:
a. at least one radio frequency ID (RFID) tag
b. wherein each said RFID tag placed on or near each said plant
c. wherein each said RFID tag transmits signals
d. wherein said AV is capable of finding each said plant location by processing each said RFID signal

20. The invention of claim 1 further comprising:
a. a funnel with a narrow pipe shaped stem and wide open mouth to allow spill-free liquid delivery,
b. wherein said funnel is inserted into the soil or supporting ground material next to said plant to be watered.

21. The method of claim 1 further comprising:
a. said AV recharging its said batteries while parked on said BU
b. said AV refilling its said tank while parked on said BU

22. The method of claim 5 further comprising:
a. said processor reading WSI stored in said memory
b. using WSI said processor determining next plant to be watered (PTW)
c. using WSI said processor determining watering time for said PTW
d. using WSI said processor determining the amount of water to be delivered to said PTW
e. using WSI said processor determining location of said PTW
f. said AV taking off at said watering time and flying towards said PTW

23. The method of claim 22 further comprising:
a. said AV finding said PTW location with GPS assistance, or
b. said AV finding said PTW location by listening to signals emitted from said RFID placed next to said PTW, or
c. said AV determining said PTW location by listening to plurality of beacon signals placed at predetermined locations

24. The method of claim 22 further comprising:
a. said processor recognizing said plant label placed on or next to said PTW using pattern recognition.

25. The method of claim 22 further comprising:
a. said AV landing next to said PTW, or
b. said AV hovering over PTW,
c. said AV dripping or spraying liquid onto said soil or said funnel.
d. if said AV still has energy left in its batteries and liquid left in its said tank flying towards a next scheduled PTW, otherwise said AV flying back to said BU for refilling said tank and recharging said batteries.
